(19) United States
(12) Patent Application Publication
(10) Pub. No.: US 2020/0155972 A1
(43) Pub. Date: May 21, 2020

(54) WATER TREATMENT PLANT AND CORRESPONDING METHOD

(71) Applicant: Veolia Water Solutions & Technologies Support, Saint-Maurice (FR)

(72) Inventors: Abdelkader GAID, Paris (FR); Hervé PAILLARD, Vernon (FR); Philippe SAUVIGNET, Saint Etienne en Cogles (FR)

(73) Assignee: Veolia Water Solutions & Technologies Support, Saint-Maurice (FR)

(21) Appl. No.: 16/628,772

(22) PCT Filed: Jun. 25, 2018
(86) PCT No.: PCT/EP2018/066985

§ 371 Date: Jan. 6, 2020

(30) Foreign Application Priority Data
Jul. 6, 2017 (FR) 1756397

(51) Int. Cl. B01D 21/01; B01D 21/00; B01D 21/08; B01D 21/24; C02F 1/52

(52) U.S. Cl. CPC B01D 21/01; B01D 21/0087; B01D 21/08; B01D 21/16; C02F 2209/40; B01D 21/2488; C02F 1/5209; C02F 2305/12; B01D 21/2472

(57) ABSTRACT

The invention relates to a water treatment plant which comprises means (38) for supplying the water to be treated, means (31) for supplying coagulant reagent (21), a flocculation-decantation device (1) which has means (32) for dispensing the flocculant reagent, means (33) for distributing ballast, means (39d) for extracting decantation sludge and means (9) for discharging water that has been treated, a line (8) for supplying coagulated water to the flocculation-decantation device (1), means (24) for separating the ballast contained in the ballasted sludge followed by means (36) for recycling the ballast back into said flocculation-decantation device (1), characterised in that said device (1) comprises an outer tank (2) that has a first hopper (4), and at least one inner tank (3) that has a second hopper (5) and is arranged inside said outer tank (2); the inner tank (3) receiving the flocculant and the ballast and comprising stirring means (10), wherein a peripheral space is disposed between the inner tank (3) and the outer tank (2); the second hopper (5) having an opening (6) which opens into the first hopper (4); and said first hopper (4) having an outlet that communicates with the means (34) for discharging ballasted sludge, wherein the means (9) for discharging water that has been treated are disposed in the upper portion of said outer tank (2). The invention also relates to a method for implementing a plant of this types.

### FIELD OF THE INVENTION

The invention relates to the field of water treatment by physiochemical means.

More precisely, the invention relates to a technique for the treatment of contaminated water such as water to be made suitable for drinking, waste town water and industrial water, rain water or sea water, to reduce the content of suspended solids in such water, and possibly its turbidity, its concentration of algae, its content of organic material and its colour.

Applications of the invention are found particularly in the context of water treatment to make it drinkable, and also in treatment of waste town water and industrial water for purification.

### PRIOR ART

Very frequently used techniques among physiochemical water treatment techniques known to the person skilled in the art include steps involving a coagulation step, a flocculation step and a decantation step.

The flocculation step is assisted by the addition of a ballasting material so as to improve the performances of these techniques. In practice, decantation of ballasted floc consists of adding a ballast, for example micro-sand, during the flocculation step so as to increase the floc density and accelerate the decantation rate. The ballast is usually recycled after separation of decanted sludge.

Patent FR2627704B1 discloses a water treatment method comprising a coagulation step, a ballasted flocculation step and a step in which floc is separated by decantation. This technique includes recycling of ballast by hydrocycloning of sludge.

Such a method can reduce organic materials contained in the water, but it requires a coagulation reactor, a flocculation reactor and a decantor. Therefore the footprint of the corresponding installations is large although these installations often need to be close to effluents, not far from or within an urban area in which available space for this type of plant is restricted and expensive.

Consequently, there is a real need to reduce the footprint of these water treatment installations.

Furthermore, the hydrocyclones used for recycling ballast consume large quantities of energy. Moreover, their separation efficiency decreases with the diameter of the particles to be separated, which can induce sometimes large ballast losses. There is a real need to improve the ballast recycling performance in this type of process.

### OBJECTIVES OF THE INVENTION

The objective of the invention is to disclose a water treatment plant making use of flocculation and decantation of ballasted floc to mitigate at least some of the disadvantages of prior art mentioned above.

In particular, one objective of this invention is to disclose such a plant that can have a smaller footprint than installations according to prior art, with equivalent treatment capacities.

Yet another objective of this invention is to disclose such a plant that, when used, leads to an improvement in liquid-solid separation performances.

Yet another objective of this invention is to disclose such a plant that can be adapted to different treatment flows and/or different qualities of water to be treated.

Yet another objective of this invention is to describe such a plant that can reduce leakage of ballast when the ballast is being recycled.

Yet another objective of this invention is to disclose a method that uses such a water treatment plant.

### PRESENTATION OF THE INVENTION

All or some of these objectives are achieved due to the invention that relates to a plant for the treatment of water comprising:

means for carrying the water to be treated,

means for carrying the at least one coagulant reagent in said water,

a flocculating-decantation device provided with means for distributing at least one flocculating reagent, means for distributing at least one ballast, means for extracting decanted sludges and means for discharging treated water,

at least one conduit for carrying coagulated water into said flocculating-decantation device,

means for separating said ballast contained in ballasted sludges followed by means for recycling said ballast thus purified towards said flocculating-decantation device,

characterised in that:

said flocculating-decantation device comprises an external vessel provided with a first hopper, and at least one internal vessel provided with a second hopper and disposed inside said external vessel;

said internal vessel receiving said flocculent and said ballast and being provided with stirring means, a peripheral space being prepared between said internal vessel and said external vessel;

said second hopper being provided with an aperture opening into said first hopper; and,

said first hopper being provided with an outlet communicating with said means for discharging ballasted sludges and said means for discharging treated water being disposed in the top part of said external vessel.

Thus, the plant according to the invention can reduce at least one element among the content of suspended solids, the turbidity, algae, the content of organic materials and the colour in the water to be treated. Coagulation according to the invention that destabilises colloidal particles is done in line or in a vessel.

Furthermore, the flocculating-decantation device makes it possible to combine the ballasted flocculating step and the decantation step, and thus significantly reduce the footprint of the plant. Flocculation occurs in the internal vessel equipped with a stirrer. In this part, the stirrer brings the ballast, the polymer and the coagulated water into intimate contact, which leads to the formation of aggregates (floc) made heavier by the ballast.

For example, the stirring means in said flocculating-decantation device is a blade stirrer.

Due to this specific configuration of said flocculating-decantation device and the judiciously selected aperture in the internal vessel hopper, the flocculated water inside said internal vessel is guided towards the bottom of said hopper of said external vessel in which the decantation and thickening of the ballasted floc occurs. “Ballasted sludges” means decanted sludges mixed with the ballast. Water without floc is discharged by overflow in an upwards circulation of fluid in the peripheral space formed between said internal vessel and said external vessel.

According to such characteristics, it is no longer necessary to install slats in the space formed between said internal vessel and said external vessel for decantation.

In practice, said ballast has a true density greater than 2.3 tonnes per meter cube and is preferably selected from among sand, ilmenite and garnet. The addition of ballast can thus increase the floc density and accelerate the decantation rate.

According to one variant of the plant according to the invention, said means for separating said ballast contained in said ballasted sludges include a pump and a separation device, said pump being capable of carrying said ballasted sludges inside said separation device.

According to another variant, these means include means for injecting air into said ballasted sludges and a separation device.

Such air injection means form an air lift by the injection of air bubbles into a vertical sludge discharge pipe. Such an air lift is conducive to entrainment of ballast by the bubbles and cleaning of the ballast due to movements created by the bubbles leading to abrasion of the agglomerate formed around the ballast so that the ballast can be separated from the remaining sludge.

Preferably, said sludge and ballast separation device includes a blade mixer or similar device rotating at high speed associated with a small decantor. The high speed mixer enables dissociation of the ballast from the remaining sludge that was already started during transport of the ballasted sludge by air lift to the separation device. The small decantation tank can collect the ballast in its bottom part and the floating sludge in its top part. Flotation of sludge can be improved by providing injection of a fluid such as air. This sludge, separated from the ballast, is extracted to a special treatment.

Communication between said internal vessel and said external vessel takes place through the aperture in said second hopper. This aperture is designed to direct flow towards the bottom of the hopper to accelerate decantation. According to a particularly interesting preferred aspect of the plant according to the invention, said aperture of said second hopper is sized to permit a speed of fluid passing through it that prevents it from becoming clogged and limits turbulence in the decantation zone. For a given passage flow, the passage velocity of the water through said aperture is inversely proportional to the area of the aperture.

According to another interesting variant of the invention, each of said vessels has a body with a cylindrical shape, said bodies being designed to be essentially concentric. Due to this cylindrical form, the structure is less expensive to construct. This cylindrical configuration also improves hydrodynamics.

In this respect, note that several internal vessels could be arranged side by side inside said external vessel.

Preferably, the water to be treated inside said internal vessel is injected in a direction approximately tangent to the cylindrical wall of said internal vessel. This can accelerate decantation.

According to another interesting variant of the invention, said first hopper and/or said second hopper is/are conical or in the shape of an inverted square-based pyramid. These structural forms facilitate decantation of ballasted floc. However, other shapes could be used, adapting them to each specific situation.

According to another particularly interesting variant of the invention, said stirring means comprise a blade stirrer and a flow guide tube, the blades of the blade stirrer being entirely located inside the internal space in the flow guide tube, the axes of said flow guide tube and said stirrer being aligned Thus, when such a stirrer is used, water circulates inside the flow guide tube in the bottom-to-top direction, and then in the peripheral zone surrounding the flow guide in the opposite direction. This can optimise the mix of water with flocculent and ballast. A fraction of the mix then circulates to the second hopper.

According to another interesting variant of the invention, said means for discharging treated water include at least one peripheral gutter at the top part of said external vessel. Thus, water without floc is discharged in overflow after upwards circulation in the space formed between said internal vessel and said external vessel.

It will be noted that according to the invention, the means of carrying in coagulant could be designed to enable coagulation of water in line or in a reactor. For coagulation in a reactor installed upstream from the flocculating-decantation device, the means of bringing in the coagulant distribute the coagulant in a reactor preferably provided with a stirrer.

The invention also relates to a method comprising a step for coagulating water, a ballasted flocculation step, a decantation step and a separation step with recycling of the decanted ballast towards said ballasted flocculation step,

characterized in that said ballasted flocculation step and said decantation step are carried out in said flocculating-decantation device in making said water travel through a circuit wherein:

said water, after said coagulation step, is led into the interior of said internal vessel in which a flocculating reagent and a ballast are added;

the water is flocculated inside said internal vessel;

the water flows from the internal vessel towards said external vessel;

the water is decanted in the space formed between said internal vessel and said external vessel, circulating from the bottom to the top;

the treated water is discharged in the top part of said external vessel; and,

the decanted sludges are extracted;

and in that the step of separating the ballast from the sludges is carried out by injection of air into said ballasted sludges without a hydrocycloning step.

Thus, the method according to the invention can create a hydrodynamic movement inside said flocculating-decantation device as a result of which the hydraulic residence time and the water flocculation are optimised and the sludge concentration is increased. The method according to the invention does not use a hydrocycloning step. This can reduce energy consumption due to separation and reduce the leakage of ballast material.

When the stirring means flocculating-decantation device comprise a flow guide like that described above, said water circulates inside the flow guide from the bottom to the top and said water present between said internal vessel and said flow guide circulates from the top to the bottom.

Preferably, the residence time of water inside said internal vessel is between 2 minutes and 10 minutes. This residence time will depend on the nature of the water to be treated, and also on the nature of the ballast used.

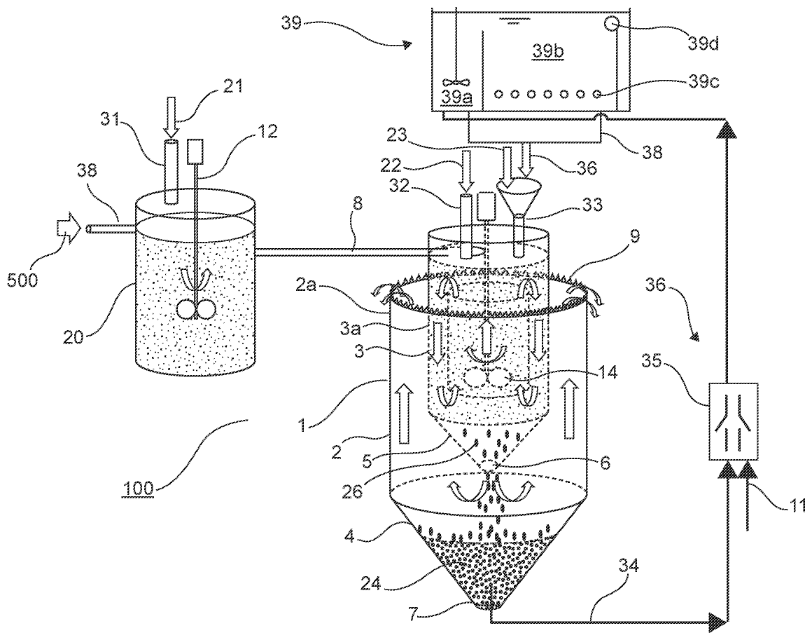

Other characteristics and advantages of the invention will become clearer after reading the following description of one preferred embodiment, given as a simple illustrative and non-limitative example, with reference to FIG. 1.

### DETAILED DESCRIPTION OF ONE EMBODIMENT OF THE INVENTION

With reference to FIG. 1, the plant according to the invention represented diagrammatically comprises a coagulation vessel 20 and a flocculating-decantation device 1.

Said coagulation vessel 20 is provided with means 38 of carrying in water 500 to be treated, means 31 of distributing a coagulating reagent 21 and stirring means 12. For example, said stirring means 12 comprise a blade stirrer, and the leading in means 38 comprise a pump.

In practice, the coagulating reagent may be organic or inorganic. It will advantageously be chosen from among aluminium sulphate, sodium aluminate, ferric chloride, ferric sulphate, ferrous sulphate, polyamines (epichlorhydrin or Polydadmac®), melamine-formol resins, polyethylenimines and some cationised plant polymers.

Said flocculating-decantation device 1 comprises an external vessel 2 provided with a first hopper 4, and an internal vessel 3 provided with a second hopper and placed inside said external vessel 2. Said vessels 2 and 3 each have a cylindrical-shaped body 2a and 3a, said bodies being essentially concentric. Said second hopper 5 is provided with an aperture 6 opening into said first hopper 4. This opening 6 is sized so that the water flow can pass through it without causing turbulence. It directs flocculated water containing floc 26 to the bottom of the hopper 4 without being dispersed, so as to not hinder decantation of the floc.

Said flocculating-decantation device 1 is provided with a coagulated water inlet duct 8, means 32 of distributing a flocculating reagent 22, means 33 of distributing a ballast 23, a discharge duct 34 for ballasted sludge 24 and means 9 of discharging treated water, for example such as gutters surrounding said external vessel 2. For example, said distribution means 31, 32 and 33 are conduits with distribution valves. For example, the flocculant reagent is chosen from among water-soluble polymers of animal or plant origin, and high molecular weight water-soluble polyelectrolytes with different ionic valences.

Said internal vessel 3 receives the flocculant 22 and the ballast 23 and is provided with stirring means 10. The stirring means comprise a blade stirrer 14 and a flow guide tube 13, the blades of the blade stirrer 14 being entirely located inside an internal space in the flow guide tube 13, the axes of said flow guide 13 and said stirrer 14 being aligned A peripheral space is formed between said internal vessel 3 and said external vessel 2. Said second hopper 5 is provided with an aperture 6 opening into said first hopper 4. Said first hopper 4 is provided with an outlet 7 communicating with the discharge conduit 34 carrying the ballasted sludge 24.

Said treated water discharge means 9 are provided near the top of said external vessel 2. For example, said treated water discharge means 9 are gutters around the external vessel 2.

The plant also comprises means for separating the ballast contained in ballasted sludges 24 followed by means 36 for recycling said ballast thus purified towards said flocculating-decantation device 1.

For example, said separation means include means 11 of injecting air in the form of bubbles into the pipe 34, to form an air lift, and a device 39 to separate the ballast contained in the sludge carried by this air lift. The separation device 39, into which the pipe 34 leads, is equipped with a blade mixer 39a rotating at high speed followed by a small decantation tank 39b fitted with an air injection manifold 39c and a floated sludge evacuation gutter 39d.

The use of an air lift not only carries ballasted sludge to the separation device but it also initiates separation of the ballast contained in it and thus reduces loss of ballast caused by the separation.

According to the invention, the separation means do not include a hydrocyclone.

Operation of such a plant will now be described.

Water 500 to be treated enters the coagulation reactor 20 in which an appropriate dose of coagulant is added to it and is intimately mixed with it. Coagulated water passes through the pipe 8 as far as the flocculating-decantation device 1 in which the ballast 23 and the flocculant 22 are added. The water is intimately mixed with the ballast and the flocculent using the stirrer 10. Movement of the blades 14 causes water circulation from bottom to top inside the flow guide 13 and from top to bottom between the flow guide 13 and the internal tank 3. This movement optimises flocculation of water. Water is then discharged passing through the opening 6 in the hopper 5 towards the external vessel. Water then transits from bottom to top in the space between the internal vessel 3 and the external vessel 2, space in which the floc formed will decante, accelerated by the ballast contained in them, towards the hopper 5 at the bottom of which they accumulate. Decanted sludge mixed with the ballast 24 is discharged from the flocculating-decantation device through the pipe 34. The means 36 of recycling the ballast contained in this sludge are connected to this pipe. Air 11 is injected through the means 35 into the sludge. The created air lift entrains sludge towards the separation device 39. Separation of ballast from the sludge that was started due to the air lift is completed in the separation device 39. In this device, the stirrer 39a rotating at high speed detaches sludge from the ballast. The sludge and the ballast are then separated in the decantor 39b equipped with an air manifold 39c. The ballast 23 is then transferred back to the flocculating-decantation device, while the floated sludge is discharged through the gutter 39d to a special treatment.

1-13. (canceled)

14. A ballasted flocculation water treatment system for treating water containing suspended solids comprising:
a line for directing the water into the system;
a coagulant line configured to direct a coagulant into the water to form a coagulated water;
a flocculating-settling device configured to receive the coagulated water and comprising:
(i) an external tank including a first hopper and a treated water outlet;
(ii) an internal tank disposed in the external tank and including a stirrer and a second hopper;
(iii) a space defined between the internal tank and the external tank;
(iv) a flocculant line configured to direct a flocculant into the internal tank;
(v) a ballast line configured to direct a ballast into the internal tank;
(vi) wherein the stirrer in the internal tank is configured to mix the flocculant, the ballast and the coagulated water and produce ballasted floc;
(vii) said second hopper including an aperture that opens into the external tank and the first hopper and which is configured to direct ballasted floc from the second hopper into the external tank;
(viii) a decantation zone in the external tank and formed at least partially below the internal tank and configured to separate the water from the ballasted floc;
(ix) wherein the first hopper forms a settling zone where the ballasted floc from the internal tank thickens and settles to form a ballasted sludge;
(x) said first hopper including an outlet configured to discharge the ballasted sludge from the first hopper; and
(xi) a ballasted sludge discharge line operatively connected to the outlet of the first hopper and configured to discharge the ballasted sludge that exits the outlet of the first hopper.

15. The system of claim 14 including a ballast separator for receiving the ballasted sludge and separating ballast from the ballasted sludge whereby the separated ballast is recycled to the internal tank.

16. The system of claim 15 wherein the ballast separator comprises a blade mixer configured to engage the ballasted sludge and cause the ballast to disassociate from the ballasted sludge; and a decantation tank configured to collect the separated ballast in a bottom portion thereof and the resulting sludge in the top portion thereof.

17. The system of claim 14 including a ballasted sludge air lift configured to receive the ballasted sludge and configured to convey the ballasted sludge to a ballast separator.

18. The system of claim 14 wherein the stirrer comprises a blade stirrer; and wherein there is a flow guide tube disposed in the internal tank and wherein the blade stirrer and flow guide tube have axes that are aligned; and wherein the blade stirrer and flow guide tube are configured to circulate the water upwardly through the flow guide tube and then reverse the flow of the water such that it flows downwardly in the space defined between the internal tanks and the flow guide tube.

19. The system of claim 14 wherein the internal and external tanks include main bodies that are generally cylindrical and wherein the internal and external tanks are concentric.

20. The system of claim 14 including an air inlet formed in the ballasted sludge discharge line and configured to inject air into the discharge line and form an air lift that conveys the ballasted sludge through the discharge line to a ballast separator.

21. A method of treating water in a flocculating-settling device comprising:
mixing a coagulant with the water to form coagulated water;
directing the coagulated water to the flocculating-settling device which includes an external tank an internal tank contained in the external tank;
directing the coagulated water into the internal tank;
directing a flocculant and a ballast into the internal tank;
with a stirrer contained in the internal tank, flocculating the water by mixing the water, the ballast and the flocculant to form a mixture containing ballasted floc;
during the course of mixing the water, the ballast and the flocculant, directing the mixture upwardly through a flow guide tube, contained in the internal tank, and directing the mixture from the top of the flow guide tube downwardly through a space defined between the internal tank and the flow guide tube;
directing the water in the internal tank downwardly through an aperture in a hopper that forms a lower part of the internal tank and into the external tank;
wherein the water in the external tank then flows upwardly through the external tank and between the external tank and the internal tank to where the water is discharged from a top portion of the external tank;
directing the ballasted floc through the aperture of the hopper of the internal tank into a hopper that forms a lower part of the external tank;
settling the ballasted floc in the hopper of the external tank and in the process yielding a ballasted sludge in the hopper of the external tank;
directing the ballasted sludge from the hopper of the external tank to a ballast separator and separating the ballast from the ballasted sludge to yield separated ballast and separated sludge; and
recycling the separated ballast to the internal tank.

22. The method of claim 21 wherein the ballast separator comprises a blade mixer and the method includes engaging the ballasted sludge with the blade mixer and disassociating the ballast from the ballasted sludge; and collecting the separated ballast in a bottom portion of a decantation tank and removing the separated sludge from a top portion of the decantation tank.

23. The method of claim 21 including directing the ballasted sludge from the hopper of the external tank into a discharge line; and injecting air into the discharge line where the air mixes with the ballasted sludge and drives the ballasted sludge through the discharge line to the ballast separator.

24. The method of claim 21 including air lifting the ballasted sludge from the hopper of the external tank to the ballast separator.

25. The method of claim 21 wherein the flocculated water inside the internal tank is guided towards the bottom of the hopper of the external tank in which decantation and thickening of the ballasted floc occurs.

26. The method of claim 21 wherein the aperture of the hopper associated with the internal tank is sized to permit the water to pass therethrough at a speed that prevents clogging and limits turbulence in a decantation zone disposed generally below the internal tank.
